(19) United States
(12) Patent Application Publication
(10) Pub. No.: US 2006/0077867 A1
(43) Pub. Date: Apr. 13, 2006

(54) Use of magnetofluidics in component alignment and jitter compensation

(75) Inventor: Anton E. Suprun, Novosibirsk (RU)

Correspondence Address: BARDMESSER LAW GROUP, P.C., 910 17TH STREET, N.W., SUITE 800, WASHINGTON, DC, 20006, US

(73) Assignee: Innalabs Technologies, Inc., Dulles, VA (US)

(21) Appl. No.: 11/216,064

(22) Filed: Sep. 1, 2005

Related U.S. Application Data
(60) Provisional application No. 60/630,224, filed on Nov. 24, 2004.
(60) Provisional application No. 60/616,849, filed on Oct. 8, 2004.

(51) Int. Cl. G11B 7/00

(52) U.S. Cl. 369/125; 359/196

(57) ABSTRACT

An optical system includes an optical component mounted relative to a housing; a fluid in contact with the housing; sources generating a magnetic field in the fluid; and a controller controlling the optical component position to maintain optical parameters of the system. The optical component is suspended using the fluid. Alternatively, a body is suspended in the fluid and a rod is connected between the body and the optical component. Sensors detect magnetic field changes in response to movement of the optical component. A method of controlling the position of an optical component includes suspending the optical component using a fluid; generating a magnetic field within the fluid; sensing magnetic field changes in response to movement of the optical component; and modulating the magnetic field to control the optical component position based on the sensed changes. Movement such as linear displacement along three axes and/or rotation about three axes can be controlled to provide up to six degrees of freedom.

### Cross-Reference To Related Applications

This application is a Non-Provisional of U.S. Provisional Patent Application No. 60/630,224, filed on Nov. 24, 2004, entitled USE OF MAGNETOFLUIDICS IN COMPONENT ALIGNMENT AND JITTER COMPENSATION, and is a Non-Provisional of Provisional Patent Application No. 60/616,849, filed on Oct. 8, 2004, entitled USE OF MAGNETOFLUIDICS IN COMPONENT ALIGNMENT AND JITTER COMPENSATION, which are both incorporated by reference herein in their entirety.

This application is related to U.S. Provisional Patent Application No. 60/614,415, entitled METHOD OF CALCULATING LINEAR AND ANGULAR ACCELERATION IN A MAGNETOFLUIDIC ACCELEROMETER WITH AN INERTIAL BODY, Atty. Docket No. 2310.0030000, Inventors: ROMANOV et al., Filed: Sep. 30, 2004; U.S. Provisional Patent Application No. 60/613,723, entitled IMPROVED ACCELEROMETER USING MAGNETOFLUIDIC EFFECT, Atty. Docket No. 2310.0020000, Inventors: SIMONENKO et al., Filed: Sep. 29, 2004; U.S. Provisional Patent Application No. 60/612,227, entitled METHOD OF SUPPRESSION OF ZERO BIAS DRIFT IN ACCELERATION SENSOR, Atty. Docket No. 2310.0040000, Inventor: Yuri I. ROMANOV, Filed: Sep. 23, 2004; U.S. patent application Ser. No. 10/980,791, filed Nov. 4, 2004; U.S. patent application Ser. No. 10/836,624, filed May 3, 2004, now U.S. Pat. No. 6,466,200; U.S. patent application Ser. No. 10/836,186, filed May 3, 2004, now U.S. Pat. No. 6,731,268; U.S. patent application Ser. No. 10/422,170, filed May 21, 2003; U.S. patent application Ser. No. 10/209,197, filed Aug. 1, 2002; U.S. patent application Ser. No. 09/511,831, filed Feb. 24, 2000; and Russian patent application No. 99122838, filed Nov. 3, 1999, which are all incorporated by reference herein in their entirety.

### BACKGROUND OF THE INVENTION

1. Field of the Invention

The present invention relates to optical systems, and more particularly, to systems and methods that use magnetofluidics in optical systems for optical component alignment and jitter compensation.

2. Background Art

Externally-induced vibrations can cause jitter and misalignment in various video, photo and other optical systems. For example, when using hand-held cameras, image blurring can occur when the camera vibrates (e.g., due to movement of the camera operator's hands). The degree of stabilization required to minimize image blurring increases with higher camera resolution. Some image stabilization systems and methods use multiple conventional accelerometers and/or gyroscopes to detect externally-induced vibrations. These systems are relatively complex and expensive. What is needed are alternative systems and methods for detecting externally-induced vibrations that have higher accuracy at lower frequencies, consume less energy, and are smaller in size and weight than those using conventional accelerometers and gyroscopes.

### BRIEF SUMMARY OF THE INVENTION

The present invention relates to systems and methods for using magnetofluidics in optical systems for optical component alignment and jitter compensation.

More particularly, in an exemplary embodiment of the present invention, an optical system includes an optical component mounted relative to a housing; a fluid in contact with the housing; a plurality of sources generating a magnetic field in the fluid; and a controller controlling a position of the optical component.

In another aspect, the optical system includes a plurality of sensors that detect changes in the magnetic field in response to movement of the optical component. The sensors can detect changes in the magnetic field in response to linear displacement of the optical component in three degrees of freedom, such as displacement along an optical axis of the optical component and in a plane perpendicular to the optical axis. The sensors can also detect changes in the magnetic field in response to rotation of the optical component in three degrees of freedom, such as rotation of the optical component about the optical axis and relative to a plane perpendicular to the optical axis.

The controller can be adapted to measure acceleration, such as linear and/or angular acceleration, based on current required by the sources to stabilize the position of the optical component.

The optical component can also include a plurality of optical elements, such as lenses, or a combination of optical elements, such as a lens and a CCD array. The controller can independently control the position of each optical element.

In another aspect, the optical system includes a body suspended in the fluid, and a rod connecting the body and the optical component. The sensors detect changes in the magnetic field in response to movement of the body. The body can be made of a partly magnetic material, a non-magnetic material, or a combination of partly magnetic and non-magnetic materials.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

FIG. 1A illustrates a cross-sectional side view of an optical system using magnetofluidic accelerometer principles for controlling a position of an optical component.

FIG. 1B illustrates a plan view of the optical system of FIG. 1A.

FIG. 1C illustrates a three-dimensional isometric view of the optical system of FIG. 1A.

FIG. 1D illustrates a cross-sectional side view of the optical component being displaced radially.

FIG. 1E illustrates a cross-sectional side view of the optical component being displaced angularly.

FIG. 2 illustrates how a control system can be used in the system illustrated in FIGS. 1A-1E.

FIG. 3A illustrates a plan view showing how magnetofluidic principles can be used to control jitter of a charge coupled device (CCD).

FIG. 3B illustrates a side view of the system of FIG. 3A.

FIG. 3C illustrates a three-dimensional isometric view of the optical system of FIG. 3A.

FIG. 3D illustrates how a control system can be used in the system of FIG. 3A.

FIG. 4 illustrates how a three-point suspension arrangement can be used to suspend an optical component using magnetofluidic principles.

FIG. 5 illustrates a method for using magnetofluidic accelerometer principles to control the position of an optical component in an optical system according to another embodiment of the present invention.

### DETAILED DESCRIPTION OF EMBODIMENTS OF THE INVENTION

Reference will now be made in detail to the embodiments of the present invention, examples of which are illustrated in the accompanying drawings.

Various embodiments of a magnetofluidic accelerometer have been described in, e.g., U.S. Provisional Patent Application No. 60/614,415, entitled METHOD OF CALCULATING LINEAR AND ANGULAR ACCELERATION IN A MAGNETOFLUIDIC ACCELEROMETER WITH AN INERTIAL BODY, Atty. Docket No. 2310.0030000, Inventors: ROMANOV et al., Filed: Sep. 30, 2004; U.S. Provisional Patent Application No. 60/613,723, entitled IMPROVED ACCELEROMETER USING MAGNETOFLUIDIC EFFECT, Atty. Docket No. 2310.0020000, Inventors: SIMONENKO et al., Filed: Sep. 29, 2004; U.S. Provisional Patent Application No. 60/612,227, entitled METHOD OF SUPPRESSION OF ZERO BIAS DRIFT IN ACCELERATION SENSOR, Atty. Docket No. 2310.0040000, Inventor: Yuri I. ROMANOV, Filed: Sep. 23, 2004; U.S. patent application Ser. No. 10/980,791, filed Nov. 4, 2004; U.S. patent application Ser. No. 10/836,624, filed May 3, 2004, now U.S. Pat. No. 6,466,200; U.S. patent application Ser. No. 10/836,186, filed May 3, 2004, now U.S. Pat. No. 6,731,268; U.S. patent application Ser. No. 10/422,170, filed May 21, 2003; U.S. patent application Ser. No. 10/209,197, filed Aug. 1, 2002; U.S. patent application Ser. No. 09/511,831, filed Feb. 24, 2000; and Russian patent application No. 99122838, filed Nov. 3, 1999.

One application for magnetofluidic accelerometer principles is in stabilization of optical components in various video, photo and other optical systems, and in reducing or eliminating the effects of jitter and misalignments that occur as a result of externally-induced vibrations.

In the exemplary embodiments described below, an optical component of an optical system can itself be used as the responsive element of the magnetofluidic accelerometer, so that simultaneous detection of externally-induced vibrations and repositioning of the optical component can be achieved using a single device. The optical component can be suspended using a fluid, such as a magnetic fluid, or a ferrofluid, that is magnetized using magnetic field sources. As the optical system moves and vibrates, the optical component changes position due to inertial forces. Thus, the change in position causes the magnetized fluid to redistribute, which in turn causes changes in the magnetic field configuration. Sensors can be used to measure these changes, and a control unit can be used to process the sensor data. The control unit can then generate a control signal that adjusts the magnetic field configuration, thereby adjusting the position of the optical component to stabilize the optical system.

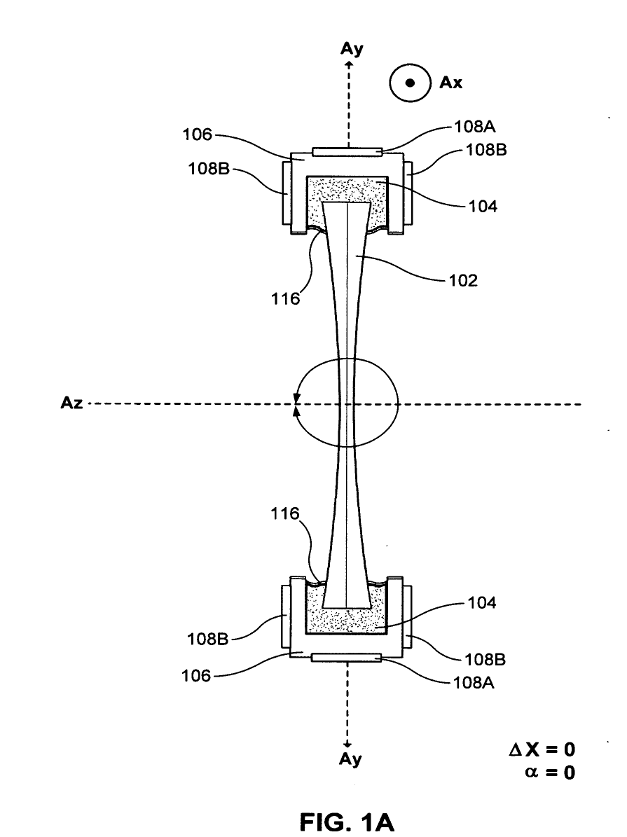

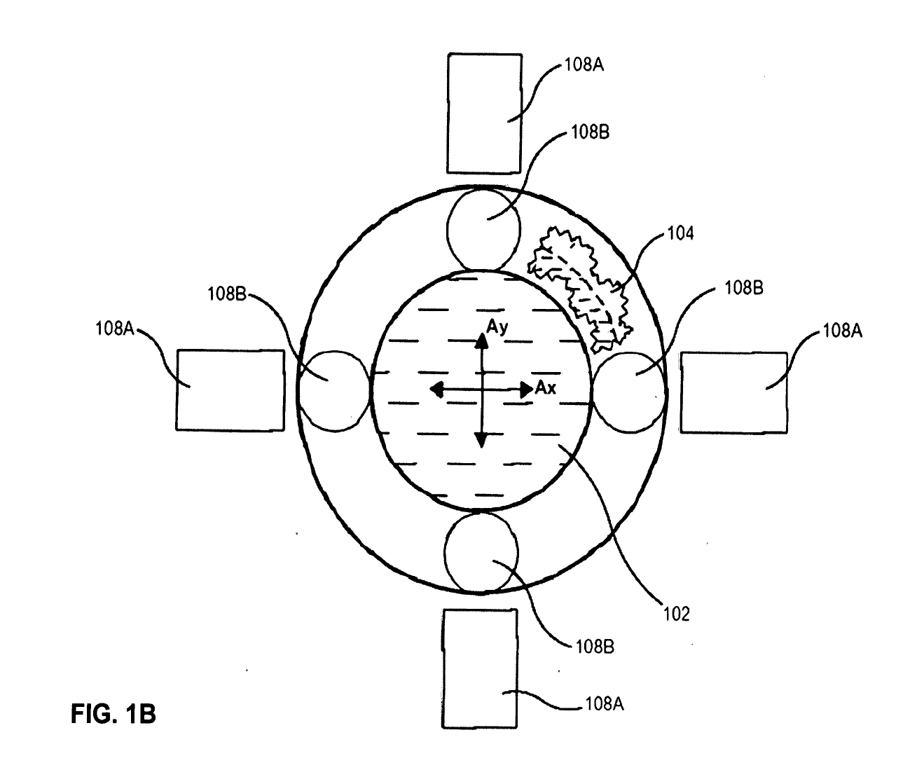

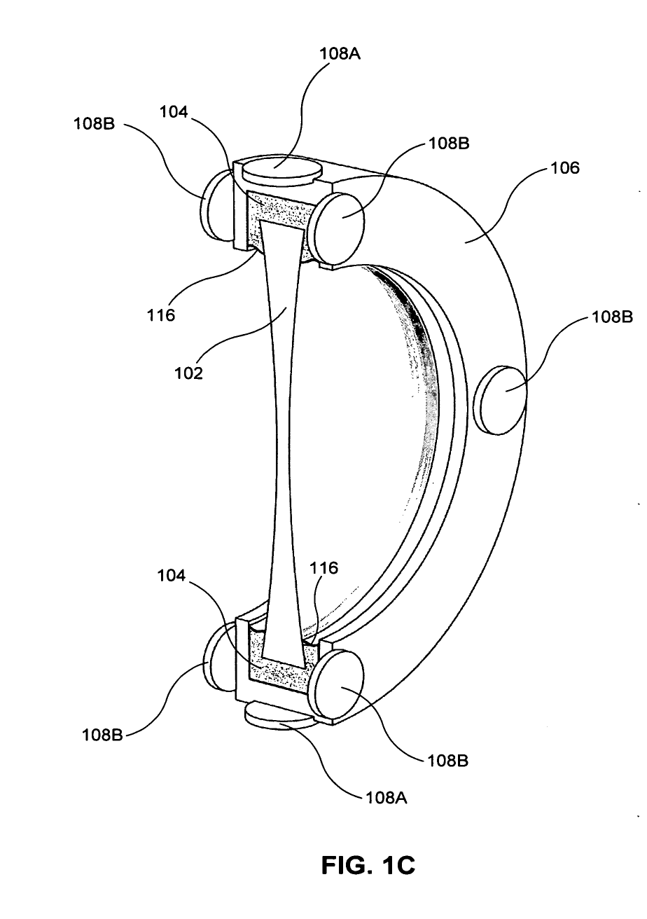

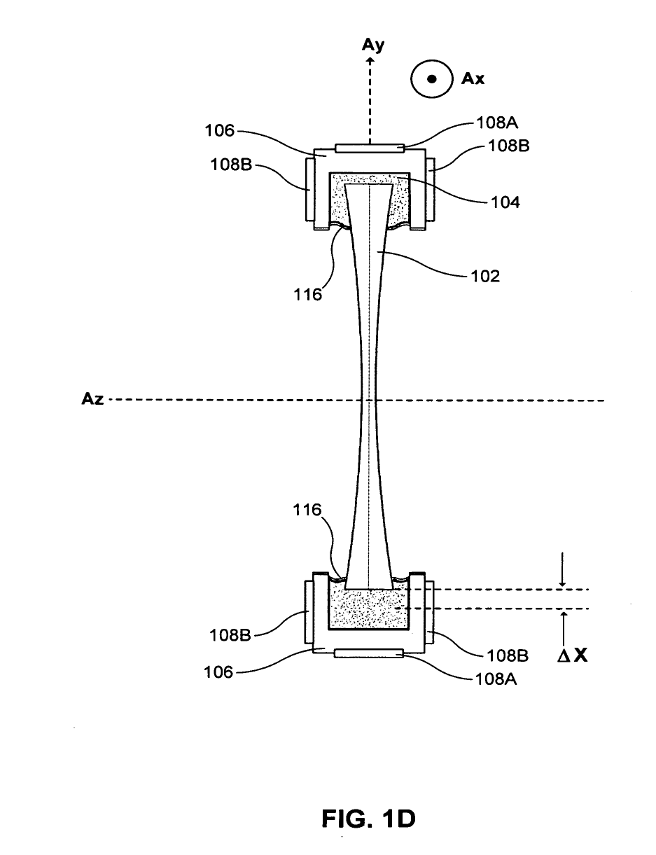

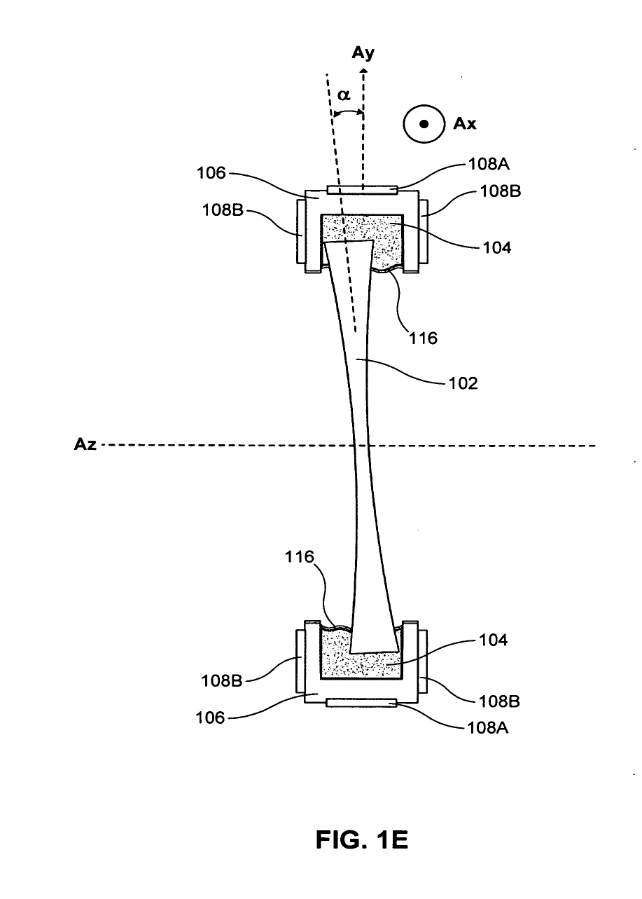

For example, in one exemplary embodiment, a lens can itself be used as the responsive element of the magnetofluidic accelerometer for detection of externally-induced vibrations and repositioning of the lens. FIG. 1A illustrates a cross-sectional view of an exemplary optical component, in this case, a lens 102, suspended using a magnetic fluid 104 and electromagnets (drive magnets) 108 (see also partial cutaway view of magnetic fluid 104 in FIG. 1B, which shows a plan view). FIG. 1C shows the structure of FIG. 1A in an isometric three-dimensional partial cutaway view. In the figures and the discussion below, the designation 108A is used for those electromagnets 108 that are used for linear position adjustment, and 108B is used for those electromagnets that are used for angular position adjustment.

The lens 102 can be mounted in a lens holder (not shown as a separate element in the figures), such that the magnetic fluid 104 is in contact with the lens holder, and at the same time, the magnetic fluid 104 is held in place using electromagnets 108 (and, optionally, using permanent magnets to ensure that the magnetic fluid 104 does not leak out, should current to the electromagnets 108 be interrupted). Note that the lens 102 effectively floats in the magnetic fluid 104. An example of such magnetic fluid 104 is a ferrofluid (i.e., a colloidal suspension of a base liquid with ferromagnetic particles suspended therein).

A housing 106 can surround the lens holder, and preferably should be made of magnetizable material, such as a permanent magnet. In another embodiment, the housing 106 can include a magnet and be formed of a material that is non-magnetic. Note also that the housing 106 need not be formed as shown in FIGS. 1A-1D, but other shapes of housing 106 can also be used.

Here the housing 106 is shown as generally round (in this case, roughly conformal with the shape of the lens 102), but this need not be the case. The housing 106 can also have a shape that is roughly conformal with other optical component shapes, or be essentially independent of the shape of the optical component.

FIGS. 1A-1C also illustrate one possible arrangement of the electromagnets 108, which can be used to compensate for both linear and rotational displacement. As shown in FIG. 1B (plan view) and FIG. 1A (cross-sectional side view), the electromagnets 108B used to compensate for rotation are positioned on the sides of the housing 106. For example, to compensate for rotation, a number of electromagnets 108 can be positioned around an upper portion of the lens 102, and a number of electromagnets 108 can be positioned around a lower portion of the lens 102. Additionally, to compensate for linear displacement, several electromagnets 108A (e.g., three to five) can be positioned around the upper portion of the lens 102, and a similar number (e.g., three to five) around the lower portion of the lens 102. It will be understood that the designations “upper” and “lower” are used solely for convenience with reference to the figures, and are entirely arbitrary and illustrative.

FIGS. 1D and 1E also show how, due to externally-induced vibrations, impacts, shocks, etc., the lens 102 can be subject to linear displacement (ΔX) and/or to rotational (angular) displacement (a). For example, FIG. 1D illustrates a linear displacement of the lens 102 due to radially directed acceleration. FIG. 1E illustrates a rotational (angular) displacement of the lens 102 due to rotational acceleration.

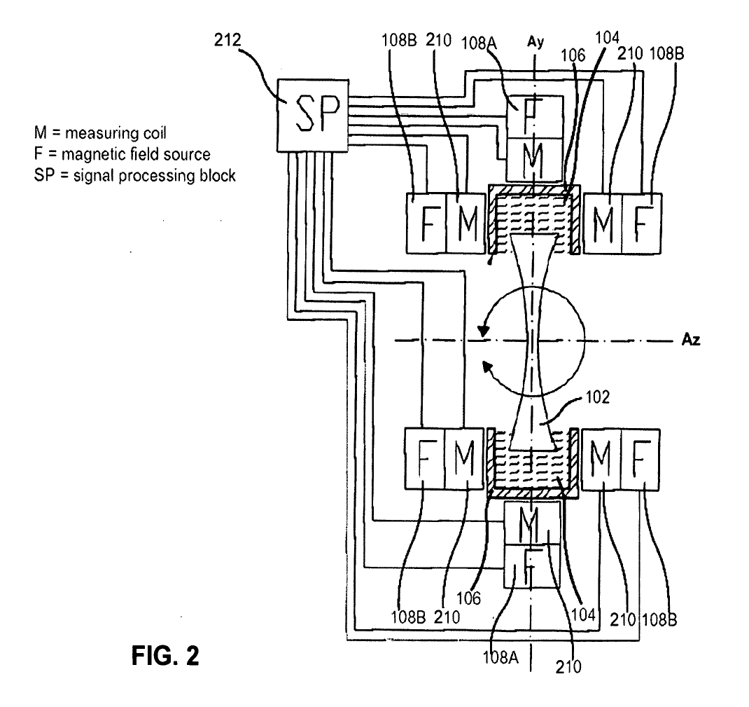

FIG. 2 illustrates additional detail of how the jitter compensation system can be implemented. For example, each electromagnet 108 (also designated by “F” in FIG. 2, which stands for “field source” or “magnetic field source”) also includes one or more measuring coils, or sensing coils 210 (also designated by “M” in FIG. 2).

Various arrangements of magnetic field sources 108 (drive coils) and sensing coils 210 are described in the related applications identified above. The magnetic field sources 108 should be positioned around the housing 106 in such a manner that the magnetic fluid 104 is magnetized by the magnetic fields generated by the magnetic field sources 108. The number of magnetic field sources 108 can be greater or fewer than shown in FIGS. 1A-1E, but a minimum of two magnetic field sources 108 positioned on opposite sides of the housing 106 are normally needed. The magnetic field sources 108 can be electromagnets, permanent magnets, or a combination of permanent magnets and electromagnets.

A signal processing block 212 (also designated by “SP” in FIG. 2) is used to process the signals received from the measuring coils 210, and to drive the electromagnets 108 so as to compensate for induced vibration and jitter.

Although the lens 102 illustrated in FIGS. 1A-1E is shown as a round (or circular) lens, the invention is not limited to round lenses, but can be applied to any other lens shape, and, essentially, to any shape of optical component (mirrors, prisms, beam splitters, gratings, CCDs, etc.), so long as it can be mounted generally in the manner illustrated in FIGS. 1A-1E and be controlled using the magnetic fluid 104 by application of a magnetic field. Additionally, the optical component itself can be made from a magnetic material, such as a magnetic plastic material with refractive properties.

Although in the discussion above only a single lens 102 has been described, it will be appreciated that this approach can be applied to optical systems utilizing multiple lenses, prisms, reflective surfaces (mirrors), gratings, variable-transparency optical components, as well as multiple such components in a single system, and to other optical components that require alignment or position control in response to external forces. When the optical system utilizes multiple optical elements, the controller/signal processing block 212 can be adapted to independently control the positions of each optical element. For example, the controller 212 can independently control the linear and/or angular positions of the individual elements, and can control the positions of the optical elements relative to each other, the housing 106, or the optical system.

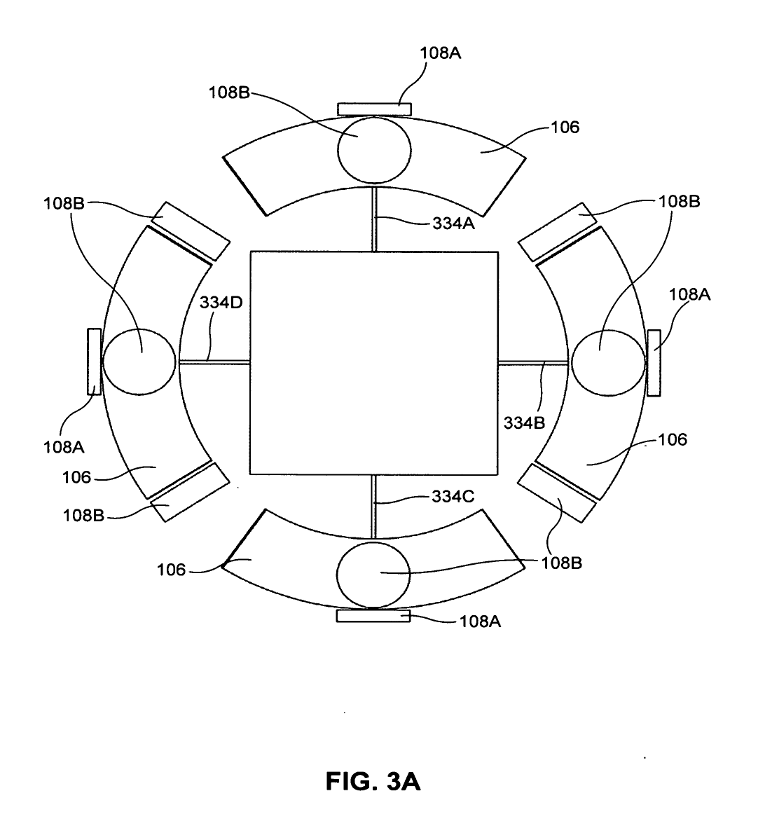

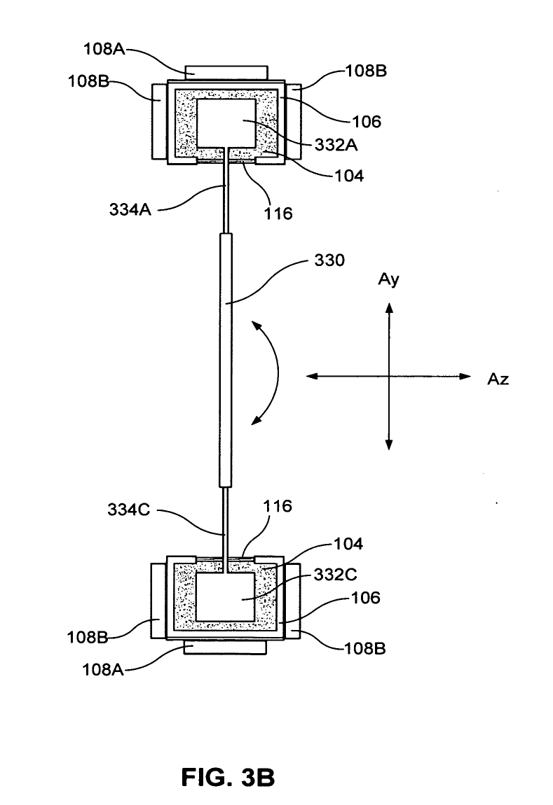

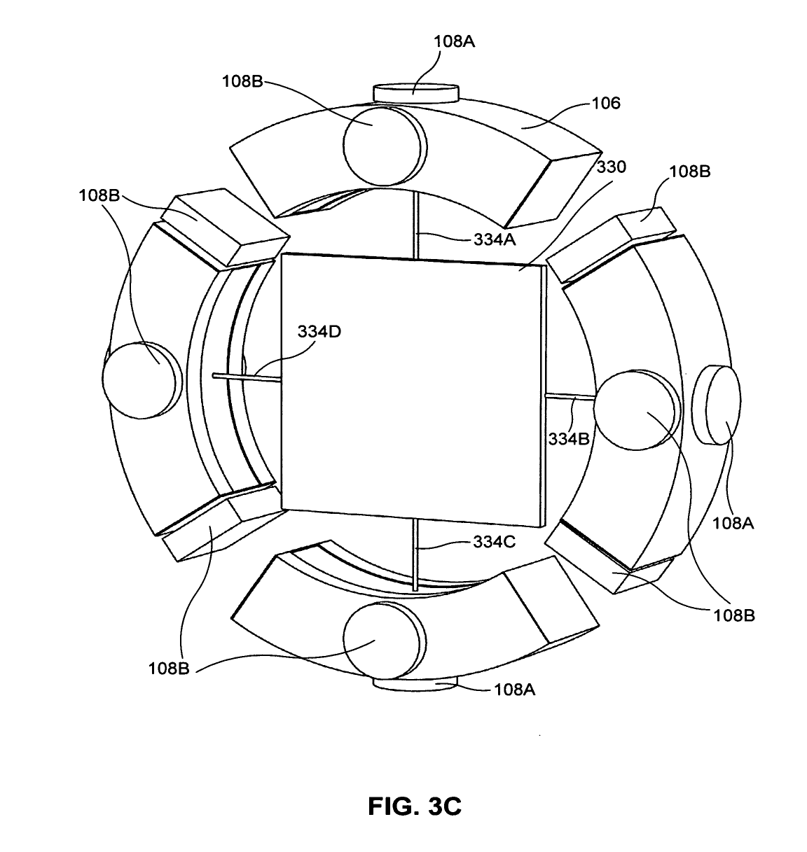

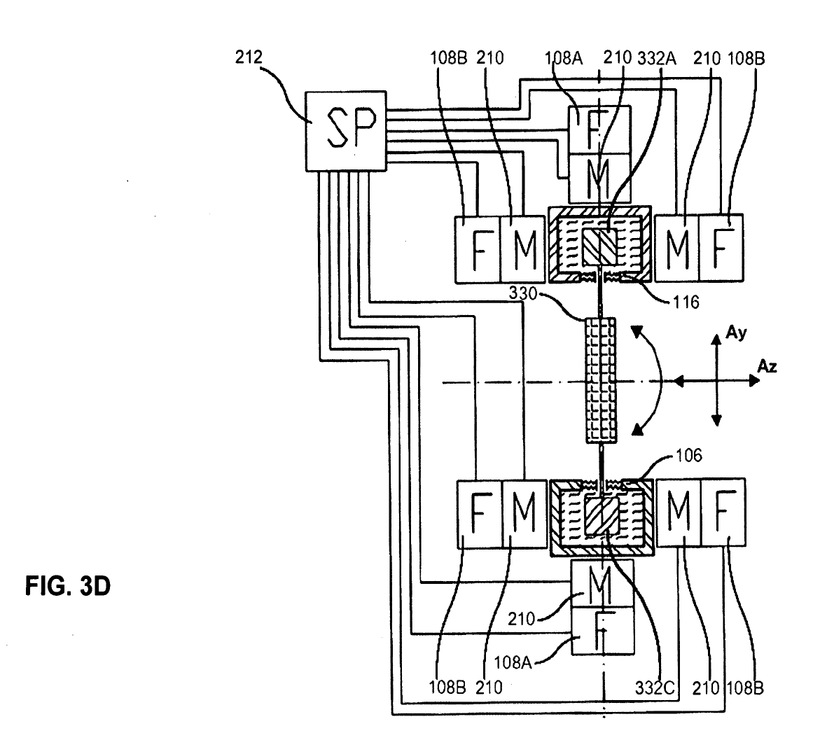

In another exemplary embodiment, a charge coupled device (CCD) array can be used as the responsive element of the magnetofluidic accelerometer for detections of externally-induced vibrations and repositioning of the CCD array. FIG. 3A shows a plan view, FIG. 3B shows a cross-sectional side view, and FIG. 3C shows an isometric three dimensional view of a CCD array 330 suspended using a system of rods (see elements 334A, 334B, 334C, 334D, collectively, 334), or other structures that achieve the same purpose, that connect the CCD array 330 to working (inertial) bodies 332 (see elements 332A, 332B, 332C, 332D) in contact with magnetic fluid 104. In effect, the entire structure comprising elements 330, 332, 334 becomes an inertial body. The rods 334 are typically rigid elements, although flexible and/or elastic elements can also be used, or can be used together with rigid elements, as part of the rods 334. A housing 106 (see FIG. 3B, not shown in FIGS. 3A and 3C) can surround the working body 332 and magnetic fluid 104, and a seal 116 can be used to maintain the magnetic fluid 104 in place. As shown in FIG. 3B, the working body 332 effectively floats in the magnetic fluid 104.

As described above, the housing 106 can be made of magnetizable material, such as a permanent magnet. In another embodiment, the housing 106 can include a magnet and be formed of a non-magnetic material. The housing 106 need not have the shape as shown in FIG. 3B, but other shapes of housing 106 can also be used.

In place of the seal 116, electromagnets 108 and, optionally, permanent magnets can be used to ensure that the magnetic fluid 104 does not leak out of the housing 106, should current to the electromagnets 108 be turned off.

The working body 332 can be made of a partly magnetic material, a non-magnetic material, or a combination of partly magnetic and non-magnetic materials. While the working body 332 is shown as having a cube shape, other working body 332 geometries can also be used, such as described in the applications listed above.

Although FIGS. 3A-3C show one possible arrangement of rods 334 and working bodies 332 for suspending the CCD array 330, it will be understood that the system can be implemented using other rod 334 and working body 332 configurations. For example, four rods 334 are shown connecting four working bodies 332 to the CCD array 330, but more or fewer rods and working bodies can also be used.

In FIGS. 3A-3C, the electromagnets 108B used to compensate for rotation are positioned on sides of the housing 106 (shown here in sectioned form, although a unitary housing can also be used). Note that while the arrangement of electromagnets 108 is similar to that shown in FIG. 1A, four additional electromagnets 108B are shown in FIG. 3A for rotating the CCD array 330 about its optical axis Az (which is perpendicular to the Ax-Ay plane defined in FIG. 3A).

FIG. 3D illustrates additional detail of how the image stabilization system can be implemented. As described above for FIG. 2, each electromagnet 108 can also include a measuring coil (or sensing coil) 210 (also designated by M), similar to FIG. 2.

A signal processing block 212 (also designated by “SP” in FIG. 3D) is used to process the signals received from the measuring coils 310, and to drive the electromagnets 108 to compensate for induced vibration and jitter.

Various arrangements of magnetic field sources 108 (drive coils) and sensing coils 210 are described in the related applications identified above. The magnetic field sources 108 should be positioned around the housing 106 in such a manner that the magnetic fluid 104 is magnetized by the magnetic fields generated by the magnetic field sources 108. The number of magnetic field sources 108 can be greater or fewer than shown in the figures discussed above, but a minimum of two magnetic field sources 108 positioned on opposite sides of the housing 106 are normally needed. Note that while the arrangement of magnetic field sources 108 and sensing coils 210 is similar to that shown in FIGS. 3A and 3B, the rod and body suspension system shown in FIGS. 3A-3C uses additional magnetic field sources (not shown in FIG. 3B) and sensing coils 210 (not shown in FIG. 3B) positioned around the housing 106, in order to sense movement of the CCD array 330 in all six degrees of freedom, and to displace the CCD array 330 in all six degrees of freedom.

Although the optical component illustrated in FIGS. 3A-3C is shown as a single CCD array 330, it will be appreciated that the optical system can be implemented with other optical components (e.g., lenses, prisms, reflective surfaces (mirrors), gratings, variable-transparency optical components, etc.) in place of the CCD array 330, or with a CCD array 330 in combination with other optical components, or with other combinations of optical components that require alignment or position control in response to external forces.

Note also that although in, e.g., FIGS. 3A-3C, four “groups” of magnetic field sources are shown, it is possible to use fewer such groups (e.g., three “groups” arranged at 120 degrees to each other).

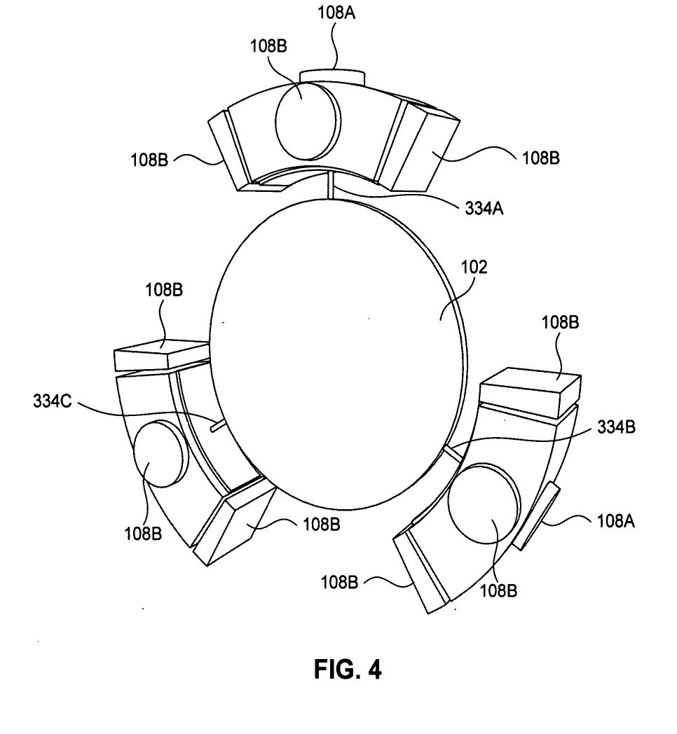

It is not necessary to suspend an optical component using all the elements shown in, e.g., FIG. 1A. A three-point suspension, such as shown in FIG. 4, can also be used, and still achieve the same range of angular and linear jitter compensation (the mathematical calculations involved are somewhat more complex, but still relatively straightforward for modern control electronics).

As yet a further option, it is possible to pivotably fix one of the suspension points shown in FIG. 4 (i.e., one of the groups of magnetic field sources 108 is removed), and the rod (or some other suspension mechanism) is fixed in place, but allowed to flex (or rotate) about a pivot point. In this manner, the compensation for angular vibration/acceleration can be achieved, but not for linear acceleration. Further still, the two of the three suspension points can be pivotably fixed, with only one of the groups of magnetic field sources 108 in FIG. 4 remaining. This way, angular compensation in one axis of rotation can be achieved, but with the advantage or reduced complexity of the overall device.

The systems shown in FIGS. 1A-4 can be used to maintain the optical component in place, to compensate for external forces by sensing movement of the optical component in up to six degrees of freedom, or to intentionally displace or rotate the optical component with up to six degrees of freedom.

For example, the systems described above can be used to compensate for linear displacement of the optical component in three axes (Ax, Ay, Az). In other words, the systems can compensate for any aberrations induced by displacement of the optical component in a plane perpendicular to its optical axis Az (i.e., along Ax, Ay), as well as to compensate for any defocusing due to displacement of the optical component along its optical axis Az (i.e., implementing active focus control).

The systems described above can also be used to compensate for rotation of the optical component in three axes (about axes Ax, Ay, Az). The primary axes of rotation of interest are Ax and Ay, as shown in, e.g., FIGS. 1A and 1B. There is usually less need to compensate for rotation of the optical component around its optical axis Az if the optical component is rotationally symmetric. However, it does matter for aspheric lenses, or for other optical components whose rotation about all three axes Ax, Ay, Az would introduce aberrations into the optical system. The systems described herein can therefore be applied to compensate for unwanted rotation about all three axes of rotation.

Additionally, the systems described above can be used to change the direction of a beam through the optical system within a certain angle, by intentionally inducing a rotation of the optical component by a desired angle. Also, the systems can be used for deliberate defocusing, if desired.

The systems described above can also use active feedback control to maintain the optical component in place to compensate for external forces or to intentionally displace or rotate the optical component. In order to implement a desired frequency response and dynamic range of the system, the signal processing block 212 shown in FIGS. 2 and 3D can include active feedback control, based on the signals received from the measuring coils 210.

The signal processing block 212 can be implemented as a stand-alone controller, as a single integrated circuit, as multiple integrated circuits, can be part of other electronics. For example, many video cameras, photo cameras, and other such similar devices have microprocessors and other signal processing electronics for implementing their functions. These microprocessors can also be used to implement feedback control as well, avoiding the need for separate electronics to implement the signal processing block 212.

The active feedback control system controls the current through the electromagnets 108, which in turn controls the intensity of the magnetic field in the magnetic fluid 104, thereby controlling the position and orientation of the optical component. For example, in the example system shown in FIG. 2, signal processing block 212 receives signals from the measuring coils M indicative of the position of the lens 102 relative to the housing 106. The signal processing block 212 then transmits signals to the magnetic field sources 108 to adjust the amount of drive current supplied to the magnetic field sources 108. The change in drive current causes a corresponding change in the intensity of the magnetic field in the magnetic fluid 104, which in turn adjusts the position and/or orientation of the lens 102.

Similarly, in the example system shown in FIG. 3D, signal processing block 212 receives signals from the measuring coils M indicative of the position of the working bodies 332 relative to the housing 106. The signal processing block 212 then transmits signals to the magnetic field sources 108 to adjust the amount of drive current supplied to the electromagnets 108. The change in drive current causes a corresponding change in the intensity of the magnetic field in the magnetic fluid 104, which in turn adjusts the position and/or orientation of the working bodies 332, thereby adjusting the position and/or orientation of the CCD array 330 suspended by the rods 334 and working bodies 332.

Note that the optical component of the systems shown in FIGS. 1A-3C (i.e., lens 102, CCD array 330) can also be used as, in effect, an inertial body to measure linear and angular acceleration. The signal processing block 212 can measure linear and/or angular acceleration based on the current required by the magnetic field sources 108 to stabilize the optical component.

Additionally, the system described herein can be used for image stabilization in video (or photographic) systems. For stabilization, the image itself can be used as a source of control information for the signal processing block 212. For example, in response to a user's command, the camera's videoprocessor outputs a high-contrast image component for stabilization and controls the drive magnets of the lens(es) of the video. The high-contrast image component provides the stable position of the selected component, and, therefore, of the entire image in the camera viewing field. Thus, only a ferrofluidic drive is required for control of the lens 102 position, without a need to measure acceleration using an inertial body.

Similarly, an independent source of jitter information, such as image analysis, can be processed by signal processing block 212 and used to adjust the position of the optical component.

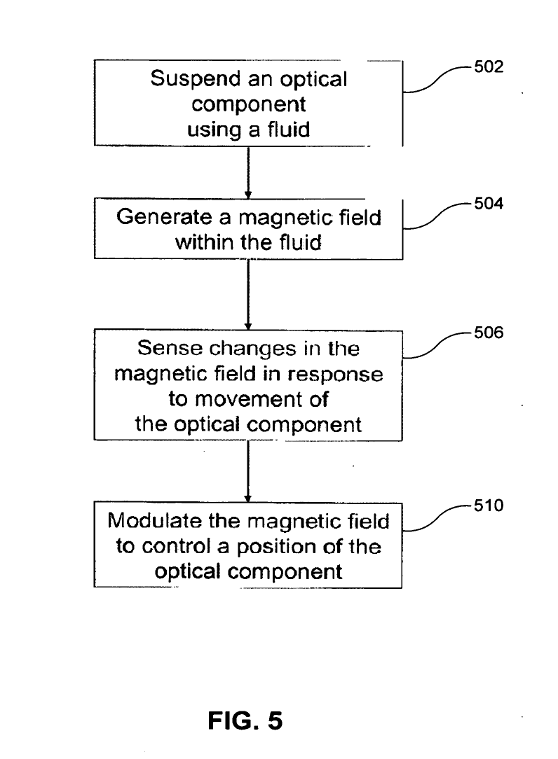

FIG. 5 illustrates an exemplary method for using magnetofluidic accelerometer principles to control the position of an optical component. The method shown in FIG. 5 includes the step of suspending an optical component using a fluid 104 (step 502). For example, the optical component can be suspended, as shown in FIG. 1A, so that the optical component is mounted in the housing 106 containing the fluid 104. Alternatively, the optical component can be suspended as shown in FIG. 3A so that the working body 332 is suspended in the fluid 104 and the rod 334 is connected between the working body 332 and the optical component.

The method shown in FIG. 5 further includes the step of generating a magnetic field within the fluid 104 (step 504). For example, the magnetic field can be generated using a plurality of magnetic field sources 108 positioned around a housing 106 containing the fluid 104. As shown in FIGS. 1A-3C, up to five or more sources can be positioned on orthogonal axes around the housing 106.

The method shown in FIG. 5 further includes the step of sensing changes in the magnetic field in response to movement of the optical component (step 506). For example, changes in the magnetic field can be sensed using a plurality of sensing coils 210 (or other sensors, e.g., Hall sensors, laser or LED sensors, electrostatic sensors, acoustic sensors, inductive coils, optical sensors, capacitive sensors, etc.) positioned around the housing 106. The sensing coils 210 can be positioned to sense changes in the magnetic field due to linear displacement of the optical component in up to three degrees of freedom and due to rotation of the optical component in up to three degrees of freedom.

The method shown in FIG. 5 further includes the step of modulating the magnetic field to control the position of the optical component (step 508). For example, the magnetic field can be modulated by driving current through the plurality of magnetic field sources 108 positioned around the housing 106. A controller, such as signal processing block 212 shown in FIGS. 2 and 3D, can be used to regulate the drive current to control the position of the optical component (e.g., such as movement due to jitter in the optical system), to defocus the optical component, and to change the direction of a beam through the optical component, among other applications.

Additionally, the method shown in FIG. 5 can include deriving acceleration, such as linear and/or angular acceleration, based on the drive current required to counteract movement of the optical component.

The method shown in FIG. 5 can also be adapted to control the position of an optical component that includes a plurality of optical elements. For example, the method can be modified to include the following steps: (a) suspending a plurality of optical elements using the fluid 104; (b) generating a magnetic field within the fluid 104; (c) sensing changes in the magnetic field in response to independent movement of the optical elements; and (d) modulating the magnetic field to independently control positions, such as linear and/or angular positions, of the optical elements. For example, the plurality of optical elements can include a CCD array 330 and the lens 102, or a plurality of lenses 102 and/or other optical components. Thus, the magnetic field can be modulated to independently control the positions of the CCD array 330 and the lens(es) 102, thereby significantly reducing the response time of the system.

Having thus described embodiments of the invention, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. An optical system comprising:
an optical component mounted relative to a housing;
a fluid in contact with the housing;
a plurality of sources generating a magnetic field in the fluid; and
a controller controlling a displacement of the optical component relative to the housing.

2. The optical system of claim 1, further comprising a plurality of sensors detecting changes in the magnetic field in response to the displacement of the optical component.

3. The system of claim 2, wherein the sensors detect changes in the magnetic field in response to linear displacement of the optical component.

4. The system of claim 3, wherein the linear displacement is in up to three degrees of freedom.

5. The system of claim 3, wherein the sensors detect changes in the magnetic field in response to the displacement of the optical component along an optical axis of the optical component.

6. The system of claim 3, wherein the displacement is in a plane perpendicular to an optical axis of the optical component.

7. The system of claim 2, wherein the sensors detect changes in the magnetic field in response to rotation of the optical component.

8. The system of claim 7, wherein the rotation is in up to three degrees of freedom.

9. The system of claim 7, wherein the rotation is about an optical axis of the optical component.

10. The system of claim 7, wherein the rotation is relative to a plane perpendicular to an optical axis of the optical component.

11. The system of claim 2, wherein, in response to the detected changes in the magnetic field, the controller adjusts current through the sources to control the displacement of the optical component.

12. The optical system of claim 1, wherein the controller drives current through the sources to control the displacement of the optical component.

13. The system of claim 12, wherein the controller measures acceleration based on current required by the sources to stabilize the optical component.

14. The system of claim 13, wherein the acceleration comprises linear acceleration and angular acceleration.

15. The system of claim 1, further comprising:
a body suspended in the fluid; and
a rod connecting the optical component and the body.

16. The system of claim 15, wherein the body comprises a partly magnetic material.

17. The system of claim 15, wherein the body comprises a non-magnetic material.

18. The system of claim 1, further comprising:
a plurality of bodies suspended in the fluid; and
a plurality of rods connecting the optical component and the bodies.

19. The system of claim 1, further comprising a seal to maintain the fluid within the housing.

20. The system of claim 1, wherein the housing comprises a magnetic material.

21. The system of claim 1, wherein the housing comprises a non-magnetic material.

22. The system of claim 1, wherein the controller is adapted to defocus the optical system.

23. The system of claim 1, wherein the controller is adapted to maintain a focus of the optical system.

24. The system of claim 1, wherein the controller is adapted to change a direction of a beam through the optical system.

25. The system of claim 1, wherein the optical component comprises any of a lens, a prism, a beam splitter, a grating, a mirror, a variable transparency optical component, and a charge coupled device (CCD) array.

26. The system of claim 1, wherein the optical component comprises a magnetic plastic material.

27. The system of claim 1, wherein the optical component comprises a plurality of optical elements, and
wherein the controller independently controls a displacment of each optical element.

28. The system of claim 27, wherein the plurality of optical elements comprises a plurality of lenses.

29. The system of claim 27, wherein the plurality of optical elements comprises a lens and a charge coupled device (CCD) array.

30. A method of controlling an optical component, comprising:
(a) suspending an optical component using a fluid;
(b) generating a magnetic field within the fluid;
(c) sensing changes in the magnetic field in response to displacement of the optical component; and
(d) modulating the magnetic field to control a displacement of the optical component based on the sensed change.

31. The method of claim 30, wherein step (c) comprises sensing the changes in response to linear displacement of the optical component using sensing coils positioned around a housing containing the fluid.

32. The method of claim 30, wherein step (c) comprises sensing the changes in response to rotation of the optical component in three degrees of freedom.

33. The method of claim 30, wherein step (d) comprises driving current through a plurality of electromagnets positioned around the fluid.

34. The method of claim 30, wherein step (d) comprises driving current through the electromagnets to counteract the displacement of the optical component.

35. The method of claim 34, wherein the method further comprises:
(e) deriving acceleration based on the current required by the electromagnets in step (d).

36. The method of claim 39, wherein step (d) comprises defocusing the optical component.

37. A method for controlling an optical component, comprising:
(a) suspending a plurality of optical elements using a fluid;
(b) generating a magnetic field within the fluid;
(c) sensing changes in the magnetic field in response to independent movement of the optical elements; and
(d) modulating the magnetic field to independently control displacement of the optical elements based on the sensed changes.

38. The method of claim 37, wherein step (d) comprises independently controlling angular displacement of the optical elements relative to each other.

39. An optical system comprising:
an optical component suspended using a fluid;
a plurality of sources generating a magnetic field in the fluid; and
a controller controlling a position of the optical component in response to a measurement of changes in the magnetic field due to displacement of the optical component.
